(19) United States
(12) Patent Application Publication
(10) Pub. No.: US 2026/0132512 A1
(43) Pub. Date: May 14, 2026

(54) CAPILLARY IMPREGNATION METHOD TO INCREASE THE INTERIOR METAL NANOPARTICLES PERCENTAGE ON CARBON SUPPORT

(71) Applicant: Toyota Motor Engineering & Manufacturing North America, Inc., Plano, TX (US)

(72) Inventors: Honghong Lin, Ann Arbor, MI (US); Griffin Canning, Ypsilanti, MI (US); Charles A. Roberts, Farmington Hills, MI (US); Liang Wang, Saline, MI (US); Gaohua Zhu, Ann Arbor, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/941,676

(22) Filed: Nov. 8, 2024

(51) Int. Cl. C23C 18/16; C23C 18/31

(52) U.S. Cl. CPC C23C 18/1603; C23C 18/31

(57) ABSTRACT

Methods are disclosed for capillary-force-assisted deposition of metal nanoparticles within selected pores of a predetermined size of a porous carbon support material useful in applications such as proton exchange membrane fuel cells (PEMFCs), water electrolyzers, and CO₂ electrolyzers, where controlling nanoparticle distribution and placement within the pore structure of the carbon support is critical for maximizing catalyst efficiency and durability.

### TECHNICAL FIELD

The present disclosure relates to methods for depositing metal nanoparticles within porous carbon supports. Specifically, it pertains to a capillary-force-assisted selective deposition process, enabling precise placement of metal precursors into micropores, mesopores, and/or macropores of the carbon support, with applications in catalysis, energy storage, and other fields requiring highly efficient and durable nanoparticle systems.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly not implicitly admitted as prior art against the present technology.

In catalytic applications, such as those involving fuel cells and energy storage devices, the performance of the catalyst is strongly dependent on the distribution, size, and location of metal nanoparticles within the support structure. Traditionally, methods for depositing metal nanoparticles often result in non-uniform particle distribution, with many nanoparticles located on the surface or in larger pores. This non-uniformity leads to inefficient catalysis, agglomeration of nanoparticles, and ultimately, catalyst deactivation.

In addition to these distribution challenges, another critical issue affecting catalyst performance, particularly in Pt-based cathode catalysts, is the interaction between the catalyst surface and the ionomer. Anions from the ionomer tend to adsorb onto the surface of Pt nanoparticles, which compromises the oxygen reduction reaction (ORR) activity. It has been reported that placing nanoparticles deeper within the pore structure of the carbon support, rather than on the external surface, can minimize direct contact with the ionomer and reduce poisoning. However, common synthesis methods, such as polyol reduction and wet impregnation, often lead to random nanoparticle distribution on both the external surface and larger pores of the carbon support, limiting the potential for improved ORR catalytic activity.

There exists a need for a method that provides controlled selective nanoparticle deposition within selected pores of a porous carbon support material, while avoiding surface deposition and aggregation leading to reduced catalytic activity.

### SUMMARY

This section provides a general summary of the disclosure and is not a comprehensive disclosure of its full scope or all of its features.

In various aspects, the present teachings provide methods for selective deposition of metal nanoparticles into a porous carbon support material. The method comprises dissolving one or more first metal precursors MP₁ in a first solvent S₁ having a predetermined surface tension ST₁ and a predetermined boiling point BP₁ to provide a first metal precursor solution MPS₁; selectively depositing the one or more first metal precursors MP1, by capillary impregnation, into selected pores having a first predetermined size P₁ of a porous carbon support material, by capillary impregnation, wherein the solvent S₁ is capable of wetting the carbon support, and wherein a volume of the first solvent V_{S1}≤the volume of the selected pores having a first predetermined size V_{P1}; evaporating the first solvent S₁ to deposit the one or more first metal precursors MP₁ selectively into the selected pores having the first predetermined size P₁ of the porous carbon support material; and annealing the porous carbon support material in a reducing atmosphere to convert the one or more first metal precursors MP₁ into metal nanoparticles confined within the selected pores of the first predetermined size P₁.

In another aspect the present disclosure provides a method further comprising dissolving one or more second metal precursors MP₂ in a second solvent S₂ having a predetermined surface tension ST₂ and a predetermined boiling point BP₂ to provide a second metal precursor solution MPS₂, wherein the predetermined surface tension of the second solvent ST₂ is 10 to 20 mN/m less than the predetermined surface tension of the first solvent ST₁, and the predetermined boiling point of the second solvent BP₂ is 10 to 20 degrees less than the predetermined boiling point of the first solvent BP₁; selectively depositing by capillary impregnation, the one or more second metal precursors MP₂ contained in the second metal precursor solution MPS₂ into pores having a second predetermined size P₂ of a porous carbon support material by capillary impregnation wherein the solvent S₂ is capable of wetting the carbon support, and wherein a volume of the second solvent V_{S2}≤the volume of the pores having a second predetermined size V_{P2}; evaporating the second solvent S₂ to deposit the one or more metal precursors into the pores of having a predetermined size P₂ of the porous carbon support material; and annealing the porous carbon support material in a reducing atmosphere to convert the one or more metal precursors into metal nanoparticles selectively confined within the pores of the first predetermined size P₁, and within the pores of the second predetermined size P₂, respectively.

In yet another aspect, the one or more precursors can be selectively deposited into pores having a third predetermined size P₃ of a porous carbon support material by increasing the volume of the second solvent V_{S2}. In some examples the predetermined surface tension ST₁ of the first solvent S₁ is in a range of 30-80 mN/m. In some examples the predetermined boiling point of the first solvent S₁ is in the range of greater than 80-200° C. In some examples, the first solvent S₁ may be a mixture of water and ethanol. In some examples, the evaporation of the first solvent S₁ is performed at a temperature of approximately 50° C.

In some examples, the second solvent S₂ is selected such that the one or more second metal precursors MP₂ is soluble in the second solvent S₂ but insoluble in the first solvent S₁. In some examples, the first solvent S₁ has a boiling point higher than 100° C. and the second solvent has a boiling point lower than 100° C. In yet some other examples, the first solvent S₁ may be a mixture of water and ethanol in a ratio of 75:25, and the second solvent S₂ is selected from acetone, chloroform or dimethylformamide.

In some examples, the one or more metal precursors may comprise a metal selected from scandium (Sc), titanium (Ti), vanadium (V), chromium (Cr), manganese (Mn), iron (Fe), cobalt (Co), nickel, (Ni), copper (Cu), zinc (Zn), yttrium (Y), zirconium (Zr), nobium (Nb), molybdenum (Mo), ruthenium (Ru), rhodium (Rh), palladium (Pd), silver (Ag), cadmium (Cd), iridium (Ir), platinum (Pt), and gold (Au). In some examples, the metal precursor is a platinum (Pt) precursor, more particularly, the metal precursor may be platinum (II) acetylactonate (Pt(acac)₂).

In the methods of the present disclosure, the pores having a first predetermined size P₁ of a porous carbon support material are micropores wherein the predetermined size P₁ is within the range of less than 2 nm; the pores having a second predetermined size P₂ of a porous carbon support material are mesopores wherein the predetermined size P₂ is within the range of 2 nm to 50 nm; and the pores having a third predetermine size P3 of a porous carbon support material are macropores wherein the predetermined size P3 is within the range of greater than 50 nm. In some examples, the porous carbon support material may be selected from ketjen black, Vulcan carbon, mesoporous acetyl black (AB), and a metal and nitrogen-doped carbon also referred to as “MNC-derived carbon”.

In a further aspect, the present disclosure provides a method for increasing the percentage of metal nanoparticles on the interior surfaces of pores of a carbon support having a hierarchical pore distribution of micropores, mesopores, and macropores. The method comprises dissolving one or more metal precursors MP₁ in a first solvent S₁ having a predetermined surface tension ST₁ and a predetermined boiling point BP₁ to provide a first metal precursor solution MPS₁; selectively depositing the one or more metal precursors into pores having a first predetermined size P₁ of a porous carbon support material by capillary impregnation wherein the solvent S₁ is capable of wetting the carbon support, and wherein a volume of the first solvent V_{S1}≤the volume of the pores having a first predetermined size V_{P1}; evaporating the first solvent S₁ to deposit the one or more metal precursors MP selectively into the micropores and not into the mesopores and/or macropores of the porous carbon support material; and annealing the porous carbon support material in a reducing atmosphere to convert the one or more metal precursors into metal nanoparticles electively confined within the micropores of the porous carbon support material.

The method may further involve dissolving one or more second metal precursors MP₂ in a second solvent S₂ having a predetermined surface tension ST₂ and a predetermined boiling point BP₂ to provide a second metal precursor solution MPS₂; wherein the predetermined surface tension of the second solvent ST₂ is 10 to 20 mN/m less than the predetermined surface tension of the first solvent ST₁, and the predetermined boiling point of the second solvent BP₂ is 10 to 20 degrees less than the predetermined boiling point of the first solvent BP₁; selectively depositing the one or more metal precursors into mesopores of a porous carbon support by capillary impregnation wherein the solvent S₂ is capable of wetting the carbon support, and wherein a volume of the second solvent V_{S2}≤the volume of the mesopores; evaporating the second solvent S₂ to deposit the one or more metal precursors into the mesopores of the porous carbon support material; and annealing the porous carbon support material in a reducing atmosphere to convert the one or more metal precursors into metal nanoparticles selectively confined within the micropores and within the mesopores of the porous carbon support, but not within the macropores of the carbon support. In some examples, the one or more precursors can be selectively deposited into the macropores of the porous carbon support by increasing the volume of the second solvent V_{S2}.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings wherein:

FIG. 1A is a schematic illustration of a prior art related polyol reduction method for forming nanoparticles on a carbon support.

FIG. 1B is a schematic illustration of a prior art related wet impregnation method for forming nanoparticles on a carbon support.

FIG. 2 is a schematic illustration of the method of the present disclosure of capillary-force-assisted wet impregnation for selective deposition of the nanoparticles within selected pores of the porous carbon material.

FIG. 3 illustrates a flow diagram for capillary-force-assisted wet impregnation method of the present disclosure for selective deposition of nanoparticles within micropores of a porous carbon material.

FIG. 4 illustrates a flow diagram for capillary-force-assisted wet impregnation method of the present disclosure for selective deposition of nanoparticles within micropores and mesopores of a porous carbon material.

FIG. 5 illustrates the principle of capillary-force-driven impregnation showing how smaller pore diameter r results in stronger capillary force drawing the solvent resulting in higher height, h, into the pore based on properties of the solvent such as surface tension γ and the contact or wetting angle θ.

FIG. 6 illustrates an example of the present disclosure for selectively depositing nanoparticles into micropores of predetermined size P₁ (filled micropores 61) while leaving pores of larger sizes P₂ (unfilled mesopores 62) and P₃ (unfilled macropores 63) empty or substantially empty.

FIG. 7 illustrates another example of the methods of the present disclosure wherein after the micropores of predetermined size P₁ are filled (filled micropores 61), and the mesopores are targeted and filled (filled mesopores 72), while leaving pores of larger size P₃ (unfilled macropores 73) empty or substantially empty.

FIG. 8 illustrates yet another example of the methods of the present disclosure for selectively deposited nanoparticles into macropores, having a third predetermined size P₃ (filled macropores 83), of a porous carbon support material.

FIGS. 9A, 9B, and 9C show SE-1, SE-2, and SE-3 images, respectively captured using the secondary electron (SE) mode of Scanning Electron Microscopy (SEM). The smooth and continuous appearance of the carbon structure in SE images indicates that platinum nanoparticles are not located on the surface of the carbon. These images show there are substantially no particles on the exterior surface of the carbon support.

10A, 10B, and 10C show STEM-1, STEM-2, and STEM-3 images, respectively, captured using Scanning Transmission Electron Microscopy (STEM) mode. The bright spots seen in the STEM images correspond to platinum nanoparticles, showing their distribution on both internal and external surfaces. Compared with the SEM images, the STEM images suggest that most nanoparticles stay inside the carbon support.

FIGS. 11A and 11B show SE and SE-3 images of the commercial Pt/Vulcan C and Pt/Vulcan C, respectively captured using the secondary electron (SE) mode of Scanning Electron Microscopy (SEM). FIG. 11A is an image of the commercial Pt/Vulcan C and shows larger, more defined structures on the surface. FIG. 11B, is an SE-3 image showing Pt/Vulcan C formed by the methods of the present disclosure.

FIGS. 12A and 12B are STEM Mode Images of the commercial Pt/Vulcan C and Pt/Vulcan C formed by the methods of the present disclosure, respectively, which provide higher-resolution details of the internal structure and nanoparticle distribution. I

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present disclosure provides methods for depositing metal nanoparticles within porous carbon supports. Specifically, it pertains to a capillary-force-assisted selective deposition process, enabling precise placement of metal precursors into micropores, mesopores, and macropores of the carbon support, with applications in catalysis, energy storage, and other fields requiring highly efficient and durable nanoparticle systems.

The present disclosure discloses methods for selectively depositing metal nanoparticles into the porous structure of a carbon support, utilizing the principles of capillary action. The present teachings provide a method for synthesizing carbon supported metal/alloy nanoparticle catalyst with selective or controlled deposition of the nanoparticles inside selected pores of a porous carbon support material. The present disclosure also provides methods for increasing the percentage of metal nanoparticles on the interior surfaces of pores of a carbon support. Yet another method provided by the present disclosure is a method of mitigating ionomer poisoning. Methods of the present disclosure involve capillary-force-assisted incipient wetness impregnation wherein capillary action is utilized to selectively deposit precursors into specific pore sizes of a porous carbon support by selecting solvents with appropriate surface tension and boiling point, the method of the present disclosure maximizes nanoparticle placement inside the pores of the carbon support structure. This leads to better performance in catalytic applications since particles inside the pores are often more stable and can have a higher surface area available for reactions. This enhances catalytic performance, especially for applications such as fuel cells, where high surface area and uniform distribution are important.

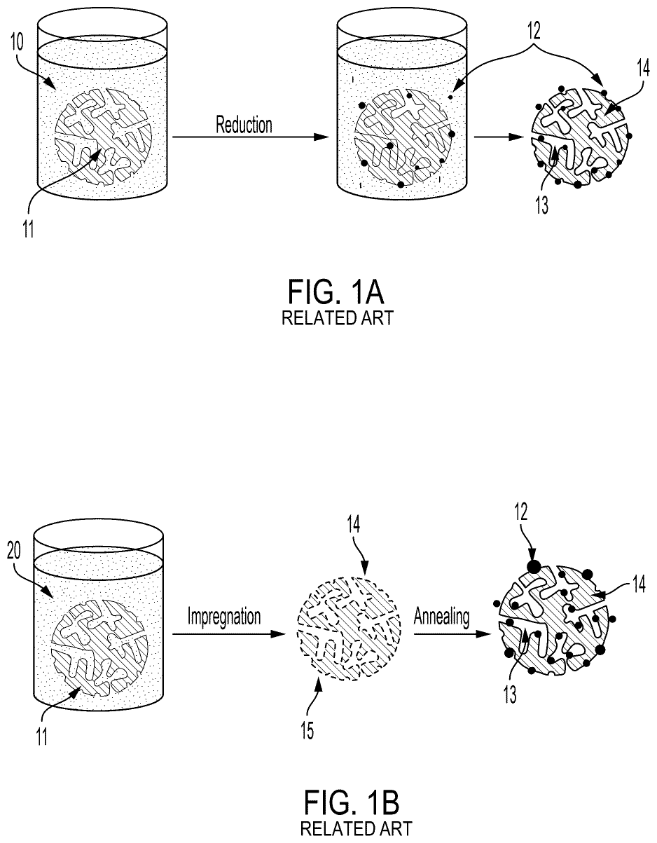

FIGS. 1A and 1B illustrate typical methods for synthesizing nanoparticles (NPs) on a carbon support, which are often used in catalytic applications such as fuel cells. FIG. 1A illustrates a polyol reduction method involving reducing metal salts in a polyol solution leading to the formation of the nanoparticles. In the polyol reduction method, a metal precursor is dissolved in a polyol solvent such as ethylene glycol which acts as both a solvent and a reducing agent to provide a polyol solution 10. A porous carbon support 11 is dispersed in the polyol solution 10. Upon heating the solution, metal ions from the metal precursor are reduced to nanoparticles 12 which are deposited primarily in larger pores 13 and on the exterior surface 14 of the carbon support 11. The polyol reduction method often leads to poor control of the nanoparticle distribution. FIG. 1B illustrates a typical wet impregnation method involving impregnating a carbon support 11 with a metal precursor solution 20 containing metal salts dissolved in a suitable solvent such as ethanol or acetone. The carbon support 11 is typically added to the metal precursor solution 20 which wets the carbon support 11 forming an impregnated carbon support. After impregnation, the solvent is evaporated leaving the metal precursor deposited on the surface of the carbon support and on the interior surfaces 16 within its pores 13 followed by annealing (heating) to produce the nanoparticles 12 distributed on the surface and within the pores 13 of the carbon support 11. In the wet impregnation method, the nanoparticles 12 achieve better distribution than polyol reduction, but the nanoparticles 12 are still distributed randomly both inside of the pores 13 and on the exterior surface 14 of the carbon support 11 with no control over where the nanoparticles form. Such random formation of many nanoparticles on the exterior surfaces of the carbon support material tends to negatively affect the ORR activity of the catalyst. Nanoparticles that form on the surface of the carbon support are exposed and often suffer from sintering (coalescence of particles due to heat) and leaching (loss of particles due to dissolution). These particles are less effective in catalytic reactions because they can agglomerate or detach from the support.

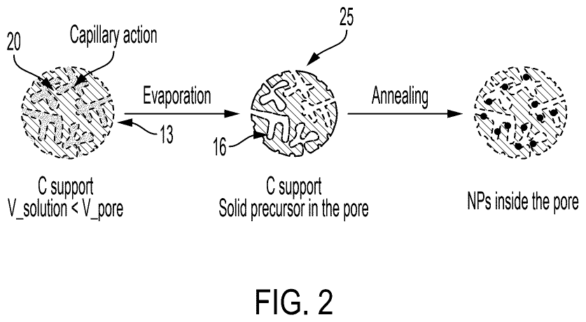

The method of the present disclosure is a capillary-force-assisted wetness impregnation method which allows for precise control and selective deposition of the nanoparticles within the pores of the porous carbon material, rather than on the surface which occurs in conventional methods such as the polyol reduction method and the wetness impregnation method. FIG. 2 illustrates the capillary impregnation method of the present disclosure wherein capillary action is employed to selectively draw the metal precursor solution 20 into pores 13 of the porous carbon support material 11. In the capillary-force-assisted method of the present disclosure, a metal precursor solution 20 is selectively deposited into pores 13 of the carbon support 11 having a predetermined size and the solution is drawn into the pores of the carbon support material through capillary action, which is a process by which liquid is naturally pulled into hollow spaces such as tubes or pores without the assistance of external forces like pressure. After the metal precursor solution 20 has been drawn into the pores 13 having the predetermined size, since the majority of the metal precursor is already inside the pores 13 due to the preceding capillary action, when the solvent is evaporated the solid metal precursor is embedded and confined within the pores of the carbon support having the predetermined size, forming a capillary-impregnated carbon support 25. Following annealing, the nanoparticles 12 are formed within the pores 13 having the predetermined size, on the interior surfaces 16, of the carbon support 11, rather than on the exterior surface of the carbon support.

The present methods further involve a controlled approach tailored to selectively deposit one or more metal precursors into different pore sizes, i.e., micropores, mesopores, and macropores, of the pores of a carbon support using a capillary-force-assisted selective deposition method. In the present method, the metal precursors are dissolved in the solvent to form the metal precursor solution and the metal precursor solution is dropped slowly onto the carbon support. The amount of the solvent used to dissolve the metal precursors is less than or equal to the volume of the pores having the desired or targeted predetermined size of the carbon support. The precursor solution will be carried into the interior surface of the carbon support by a stronger capillary force. The metal percentage on carbon can be controlled by the total amount of the precursor solution added onto the support. The carbon support that adsorbs the metal precursor inside of its pores is then annealed in a reducing atmosphere to convert the metal precursors to metal nanoparticles. Due to capillary action, the selected pores of predetermined size will be filled, with the extent of filling controlled by factors such as the solvent's surface tension and pore volume, enabling flexible control of particle distribution on the interior surfaces and embedded within the interior of the selected pores. Compared to prior wet impregnation using excess solvent, the present method avoids the deposition of metal precursor on the exterior surfaces of the carbon support material. When the reduction reaction of the metal precursor occurs, the metal nanoparticles will preferentially grow within the pores and/or on the interior surfaces of the pores, which also helps to prevent the agglomeration of the nanoparticles under high-temperature annealing processes.

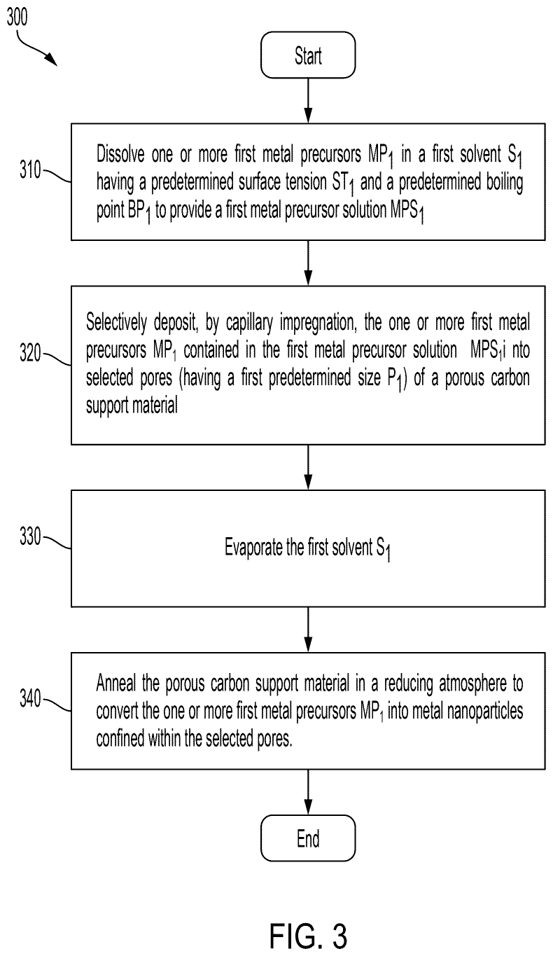

In accordance with an embodiment, FIG. 3 illustrates a flowchart of the method 300 for selective deposition of metal nanoparticles into micropores of a porous carbon support material of the present disclosure.

Illustrated process block 310 includes dissolving one or more first metal precursors MP₁ in a first solvent S₁ having a predetermined surface tension ST₁ and a predetermined boiling point BP₁ to provide a first metal precursor solution MPS₁.

The method proceeds to illustrated process block 320, which includes selectively depositing, by capillary impregnation, the one or more first metal precursors MP₁ contained in the first metal precursor solution MPS₁ into selected pores of a porous carbon support material, the selected pores having a first predetermined size P₁.

In accordance with illustrated process block 320, the first solvent S₁ is capable of wetting the carbon support material.

In accordance with illustrated process block 320, a volume of the first solvent V_{S1} is less than or equal to the volume of the selected pores VP₁ having a first predetermined size V_{P1}.

The method 300 proceeds to illustrated process block 330, which includes evaporating the first solvent S₁ to selectively deposit the one or more metal precursors MP₁ into the selected pores of the porous carbon support material.

The method 300 proceeds to illustrated process block 340, which includes annealing the porous carbon support material in a reducing atmosphere to convert the one or more metal precursors MP₁ into metal nanoparticles confined within the selected pores of the first predetermined size P₁. The process can terminate or end after completion of illustrated process block 340.

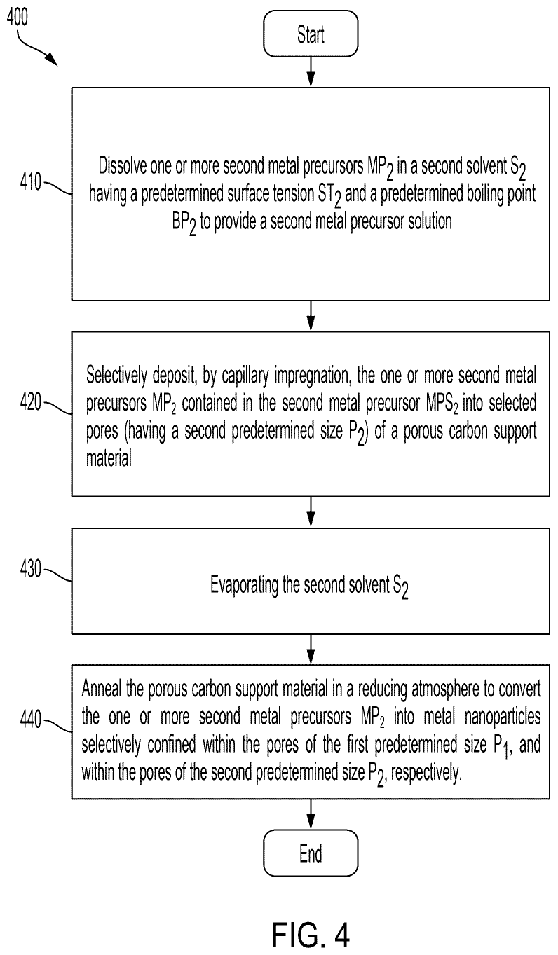

In accordance with another embodiment, FIG. 4, illustrates a flowchart for the method 400 for selective deposition of metal nanoparticles into both micropores and mesopores, i.e., on the interior surfaces and/or within the interior of the selected micropores and mesopores of the porous carbon support material of the present disclosure.

The method comprises selectively filling the micropores as described above and may further comprise illustrated process block 410, which includes dissolving one or more second metal precursors MP₂ in a second solvent S₂ having a predetermined surface tension ST₂ and a predetermined boiling point BP₂ to provide a second metal precursor solution MPS₂. In accordance with illustrated process block 410, the predetermined surface tension of the second solvent ST₂ is 10 to 20 mN/m less than the predetermined surface tension of the first solvent ST₁, and the predetermined boiling point of the second solvent BP₂ is 10 to 20 degrees less than the predetermined boiling point of the first solvent BP₁.

The method 400 proceeds to illustrated process block 420 which includes selectively depositing, by capillary impregnation, the one or more second metal precursors MP₂ contained in the second metal precursor solution MPS₂ into selected pores of a porous carbon support material, the selected pores having a second predetermined size P₂.

In accordance with illustrated process block 420, the second solvent S₂ is capable of wetting the carbon support material.

In accordance with illustrated process block 420, a volume of the second solvent V_{S2} is less than or equal to the volume of the pores having a second predetermined size V_{P2}.

The method 400 proceeds to illustrated process block 430, which includes evaporating the second solvent S₂ to selectively deposit the one or more second metal precursors MP₂ into the selected pores of the porous carbon support material.

The method 400 proceeds as shown in illustrated process block 440, which includes annealing the porous carbon support material in a reducing atmosphere to convert the one or more metal precursors MP₂ into metal nanoparticles confined within the selected pores of the first predetermined size P₁. The process can terminate or end after completion of illustrated process block 440.

Methods of the present disclosure are effectively applied for selective deposition of metal nanoparticles within into a porous carbon support having a hierarchical pore distribution of micropores, mesopores, and macropores, which involves dissolving one or more metal precursors MP₁ in a first solvent S₁ having a predetermined surface tension ST₁ and a predetermined boiling point BP₁ to provide a first metal precursor solution MPS₁; selectively depositing the one or more metal precursors into the micropores of a porous carbon support material by capillary impregnation wherein the solvent S₁ is capable of wetting the carbon support, and wherein a volume of the first solvent V_{S1}≤the volume of the micropores; evaporating the first solvent S₁ to deposit the one or more metal precursors MP selectively into the micropores and not into the mesopores and/or macropores of the porous carbon support material; and annealing the porous carbon support material in a reducing atmosphere to convert the one or more metal precursors into metal nanoparticles electively confined within the micropores of the porous carbon support material.

Another embodiment of the method for selective deposition of metal nanoparticles within into a porous carbon support having a hierarchical pore distribution of micropores, mesopores, and macropores comprises dissolving one or more second metal precursors MP₂ in a second solvent S₂ having a predetermined surface tension ST₂ and a predetermined boiling point BP₂ to provide a second metal precursor solution MPS₂, wherein the predetermined surface tension of the second solvent ST₂ is 10 to 20 mN/m less than the predetermined surface tension of the first solvent ST₁, and the predetermined boiling point of the second solvent BP₂ is 10 to 20 degrees less than the predetermined boiling point of the first solvent BP₁; selectively depositing the one or more metal precursors into mesopores of a porous carbon support by capillary impregnation wherein the solvent S₂ is capable of wetting the carbon support, and wherein a volume of the second solvent V_{S2}≤the volume of the mesopores; evaporating the second solvent S₂ to deposit the one or more metal precursors into the mesopores of the porous carbon support material; and annealing the porous carbon support material in a reducing atmosphere to convert the one or more metal precursors into metal nanoparticles selectively confined within the micropores and within the mesopores of the porous carbon support, but not within the macropores of the carbon support. The one or more precursors can be selectively deposited into the macropores of the porous carbon support by increasing the volume of the second solvent V_{S2}.

Once the metal precursors are deposited within the desired pores of the carbon support, the carbon support is subjected to an annealing process. The annealing temperature is typically between 400° C. and 600° C., depending on the metal precursor used. For example, platinum precursors may require annealing at around 500° C. to reduce the metal precursor and form nanoparticles within the pores. Other metals: palladium, ruthenium, or other metals may require similar or slightly different annealing temperatures, typically in the range of 300-700° C., depending on the reduction environment (e.g., in hydrogen or inert atmosphere).

In the methods of the present disclosure, the one or more first and/or one or more second metal precursors MP₁ and/or MP₂ must be soluble in the selected solvent and capable of undergoing reduction during the annealing process to form metal nanoparticles. The precursor choice depends on the target metal for the catalyst. The one or more first and/or one or more second metal precursors MP₁ and/or MP₂ may comprise a metal selected from scandium (Sc), titanium (Ti), vanadium (V), chromium (Cr), manganese (Mn), iron (Fe), cobalt (Co), nickel, (Ni), copper (Cu), zinc (Zn), yttrium (Y), zirconium (Zr), niobium (Nb), molybdenum (Mo), ruthenium (Ru), rhodium (Rh), palladium (Pd), silver (Ag), cadmium (Cd), iridium (Ir), platinum (Pt), and gold (Au). The one or more first and/or one or more second metal precursors MP₁ and/or MP₂ may be the same or different depending on the design for user's need. For example, for a CO₂ reduction reaction, tandem catalysis has been found to be beneficial to achieve a high yield of two-carbon products. Ag and Au have been known to be monometallic catalysts promoting CO₂ to CO formation, while Cu is good for promoting CO₂ to a two-carbon product. To make a catalyst combining Ag or Au with Cu, this method can be applied. In some examples the one or more first and/or one or more second metal precursors MP₁ and/or MP₂ may be selected from platinum (Pt) precursors, palladium (Pd) precursors, copper (Cu) precursors, nickel (Ni) precursors, iron (Fe) precursors, ruthenium (Ru) precursors, and gold (Au) precursors. In at least one example the one or more first and/or one or more second metal precursors MP₁ and/or MP₂ is a platinum containing metal precursor, such as platinum (III) acetylacetonate (Pt(acac)₂), platinum chloride (H₂PtCl₆), platinum nitrate (Pt(NO₃)₂), K₂PtCl₆, Pt(ac)₂, [NH₄]₂[PtCl₆]. Other examples include bi-metallic metal precursors such as PdCl₂, RuCl₃, or HAuCl₄.

The first solvent S₁ is chosen for its ability to selectively penetrate the micropores of the carbon support through capillary action. Suitable solvents for S₁ for the capillary impregnation methods of the present disclosure should have a high surface tension and a high boiling point. A high surface tension allows the solvent to be drawn deeper into the pores of the porous carbon support and a high boiling point ensures the solvent doesn't evaporate too quickly during the impregnation process, allowing time for the solvent to enter the micropores. In some examples, the evaporation of the first solvent S₁ is performed at a temperature of approximately 50° C.

In the context of the present disclosure, a “high surface tension” of and/or ST₁ refers to a surface tension within the range of 30-80 mN/m or 40-80 nM/m or 60-80 mN/m and a “high boiling point” refers to a boiling point of ≥80° C. or ≥100° C. or ≥175° C. or ≥200° C. Some examples include, but are not limited to water (H₂O, surface tension: ˜72.8 mN/m; boiling point: ˜100° C.), glycerol (C₃H₈O₃, surface tension: ˜63.4 mN/m; boiling point: ˜290° C.), ethylene glycol (CH₂OH₂, surface tension: ˜47.7 mN/m; boiling point: ˜197° C.), diethylene glycol ((HOCH₂CH₂)₂O, surface tension: ˜34.4 mN/m; boiling point ˜244° C.), and mixtures thereof. In some examples, the solvent may a mixture of water and ethanol (H₂O/EtOH, surface tension at 25% EtOH ˜40 mN/m; boiling point: ˜83° C., surface tension, or at 15% EtOH ˜46 mN/m, boiling point ˜84° C.

The second solvent S₂ is selected such that the one or more second metal precursors MP₂ is soluble in the second solvent S₂ but insoluble in the first solvent S₁. Suitable solvents for S₂ should have a lower surface tension and lower boiling point than solvent S₁. For purposes of this disclosure “lower surface tension” for S₂ means at least 10 to 20 mN/m less than the predetermined surface tension of the first solvent S₁, and “lower boiling point” means at least 10 to 20° C. less than the predetermined boiling point of the first solvent S₁. Some examples include but are not limited to the solvents for S₁ as long as the chosen S₂ solvent has a lower ST and BP than the chosen S₁ solvent, and additionally acetone (C₃H₆O, surface tension ˜25.5 mN/m; boiling point ˜56° C.), chloroform (CHCl₃, surface tension ˜27.5 mN/m, boiling point 61.2° C.), and dimethylformamide (C₃H₇NO, surface tension ˜36.8 mN/m, and boiling point ˜153° C.).

Suitable solvents for S₁ and/or S₂ should also have good wetting properties allowing it to spread and penetrate the selected pores and effectively wet the carbon surface. In this regard, the contact angle (θ) should be low, for example, 0<θ<90°, to ensure that the solvent spreads out inside the selected pores. A smaller contact angle leads to better solvent penetration into the pores. Water-based solvents are often good wetting agents, but the specific solvent should match the surface energy of the carbon.

Capillary action is the process by which the metal precursor solution is drawn into the pores due to surface tension and the interaction between the solution and the pore walls. The depth to which the solution is drawn into pores of a predetermined size can be predicted by the following formula:

$$h = ( 2 γ cos θ ) / ( ρ gr )$$

where γ is the surface tension of the solvent, θ is the contact angle or wetting angle between the solvent and the carbon surface, r is the radius of the pore, ρ is density of the solvent; and g is the gravitational acceleration constant.

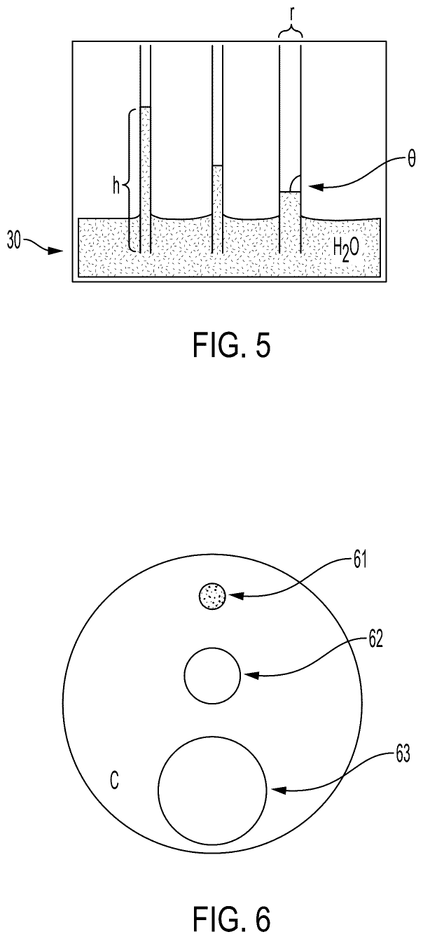

In this context, the solvent's surface tension and wetting properties are key to selecting which pores of predetermined size will be filled. FIG. 5 demonstrates this principle of capillary-force-driven impregnation: for a wetting solvent 30 e.g., water, and smaller pore diameter r results in higher capillary rise h, but by adjusting the solvent's properties (such as surface tension γ and the contact or wetting angle θ, selective deposition into targeted pore sizes can be achieved. This control ensures that the metal precursor solution can effectively impregnate the desired pores within the carbon support.

Porous carbon support materials such as ketjen black, Vulcan carbon, mesoporous acetyl black (AB), and a metal and nitrogen-doped carbon also referred to as “MNC-derived carbon”, typically have a hierarchical pore distribution of pores of different sizes, i.e., micropores, mesopores, and macropores. The present disclosure may also be applied to other types of porous supports such as alumina, silica, and zeolites. The pore volume of carbon support materials may vary from one type of carbon to another. The pore volume of micro-, meso-, and macro-pores can be measured via Brunauer-Emmett-Teller (BET) analysis.

In the present disclosure, micropores are pores having a first predetermined size P₁ of a porous carbon support material wherein the predetermined size P₁ is within the range of less than 2 nm; mesopores are pores having a second predetermined size P₂ of a porous carbon support material wherein the predetermined size P₂ is within the range of 2 nm to 50 nm, and macropores are pores having a third predetermined size P₃ of a porous carbon support material wherein the predetermined size P₃ is within the range of greater than 50 nm. FIG. 6 illustrates an example of the present disclosure for selectively depositing nanoparticles into micropores of predetermined size P₁ (filled micropores 61) while leaving pores of larger sizes P₂ (unfilled mesopores 62) and P₃ (unfilled macropores 63) empty or substantially empty. In this example, metal precursors MP₁ are dissolved in solvent S₁ to form a metal precursor solution MPS₁. The solvent S₁ used to dissolve the metal precursors MP₁ should have a high surface tension and a high boiling point to ensure the precursor solution enters the micropores via capillary action. The volume of solvent used is adjusted to be less than or equal to the volume of the micropores (Vₛₒₗᵥₑₙₜ≤V_{micropore}) to ensure that only the micropores are filled 61 and that it doesn't spill into larger pores, i.e., unfilled mesopores 62 and unfilled macropores 63 or the surface of the carbon support. Larger pores, i.e., unfilled mesopores 62 and unfilled macropores 63 and the surface areas of the carbon support are intentionally left empty to avoid nanoparticle formation on the surface or in mesopores and macropores, which can reduce catalyst efficiency. After evaporation of the solvent, the metal precursors remain inside micropores 61. These precursors are then reduced and converted into metal nanoparticles through annealing, leading to nanoparticle formation inside the micropores.

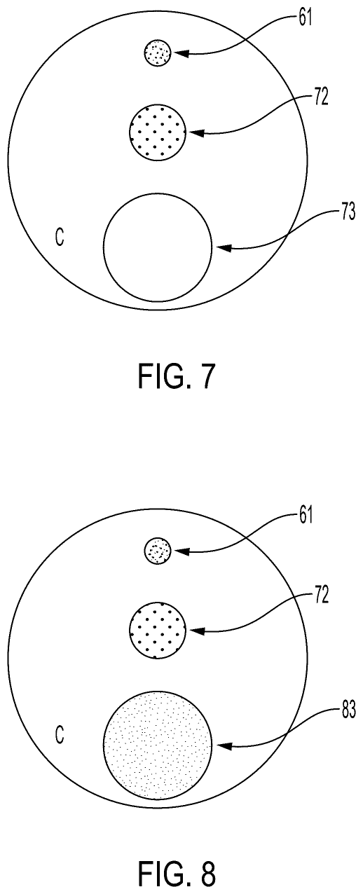

FIG. 7 illustrates another example of the methods of the present disclosure wherein after the micropores are filled, i.e., filled micropores (P₁) 61, the mesopores are targeted for filling. In this example, metal precursors MP₂ are dissolved in a second solvent S₂ to form a metal precursor solution MPS₂. The second solvent S₂ used to dissolve the metal precursors MP₂, has a lower surface tension and boiling point than the first solvent S₁. In this example, the volume of the second solvent S₂ is adjusted to be less than or equal to the volume of the mesopores (V_{S2}≤Vₘₑₛₒₚₒᵣₑₛ). The second solvent S₂ is then evaporated, leaving the metal precursors deposited inside the mesopores, i.e., filled mesopores 72. Larger pores remain empty or substantially empty, i.e., unfilled macropores 73.

FIG. 8 illustrates yet another example of the methods of the present disclosure wherein one or more precursors can be selectively deposited into macropores, i.e., filled macropores 83, having a third predetermined size P₃ of a porous carbon support material by increasing the volume of the second solvent V_{S2} to an amount less than or equal to the volume of the macropores (V_{S2}≤V_{macropores}). The third solvent S₃ is then evaporated, leaving the metal precursors deposited inside the macropores, i.e., filled macropores 83.

### EXAMPLES

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Deposition of Platinum Nanoparticles in Micropores

Example 1: Vulcan carbon (surface area=228, total pore volume=0.4 cm³/g,) a porous carbon support material having micropores, mesopores and macropores was thermally treated in air at 300° C. overnight for removing moisture prior to use.

The carbon support material was then added into one flask connected with Schlenk line. The system was evacuated to remove the air in the support pores. Commercial 20% Pt(acac)₂ was dissolved in an ethanol/water (EtOH/H₂O) mixture (25% EtOH/75% H₂O), surface tension=40 mN/m; boiling point=84° C.) to form the metal precursor solution. The precursor solution was added gradually to the support under vacuum and vigorous stirring. The volume of the solvent for the precursor solution (0.06 cm³/g for 1 g of Vulcan carbon) was equal or less than the volume of the micropores (0.06 cm³/g). The support material rapidly absorbed the precursor solution, suggesting effective impregnation of the precursors into the support micropores. After the impregnation, the mixture was transferred to a furnace which was then purged by N₂ flow for 20 minutes. The mixtures were reduced by being heated at a ramping rate of 20° C./min to 400° C. and maintaining at the temperature for 1 hour in 7% H₂ in argon. The gas atmosphere was switched back to N₂ and the product was cooled down to room temperature after the reaction was complete. The Pt/Vulcan carbon nanoparticles were then collected.

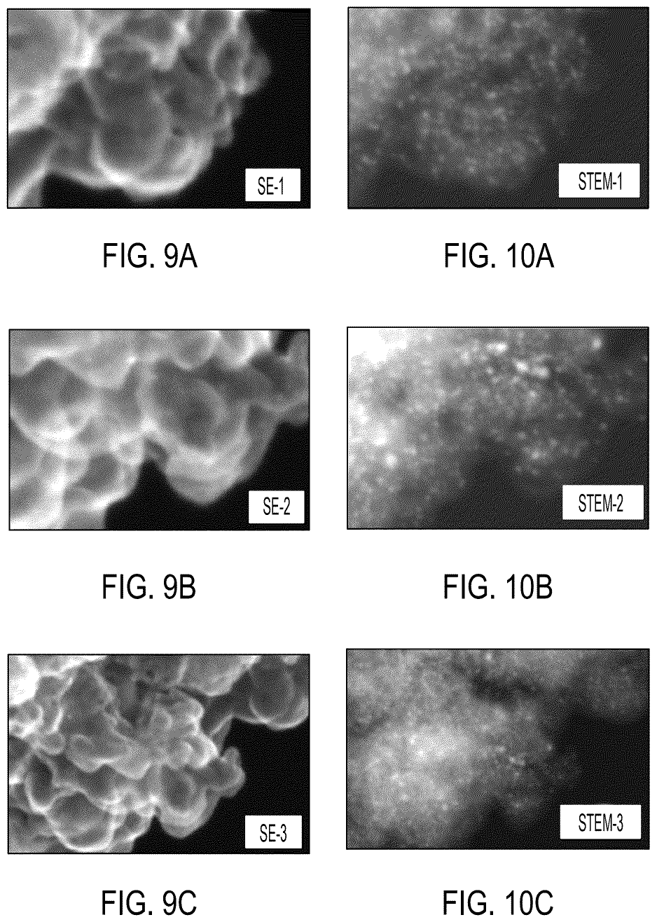

Images of the Pt/Vulcan carbon nanoparticles were captured using Scanning Electron Microscopy (SEM) in two modes: Scanning mode (SE), which captures images by detecting secondary electrons that are emitted from the sample surface when the sample is bombarded by a focused electron beam; and Scanning Transmission Electron Microscopy (STEM) mode, which uses a finely focused electron beam to detect very small nanoparticles and their location within a porous structure at a higher resolution than conventional SEM. FIGS. 9A, 9B, and 9C show SE-1, SE-2, and SE-3 images, respectively captured using the secondary electron (SE) mode of Scanning Electron Microscopy (SEM). These images show there are substantially no particles on the exterior surface of the carbon support. The smooth and continuous appearance of the carbon structure in SE images indicates that platinum nanoparticles are not located on the surface of the carbon. This suggests that the capillary impregnation method effectively prevented the formation of platinum nanoparticles on the exterior, favoring their deposition inside the carbon's pore structure. Thus, it can be seen that by controlling the volume of solvent (which was set to be equal to the total of micro-, meso-, macropores), the particles can be embedded into the interior of the carbon support material, rather than deposited on the external carbon surface.

FIGS. 10A, 10B, and 10C show STEM-1, STEM-2, and STEM-3 images, respectively, captured using Scanning Transmission Electron Microscopy (STEM) mode. These images reveal the presence of nanoparticles inside the carbon support. The bright spots seen in the STEM images correspond to platinum nanoparticles, showing their internal distribution. The contrast between the dark background (carbon support) and the bright spots (platinum) shows that the nanoparticles are embedded within the pores of the carbon material. This confirms that the capillary impregnation method successfully confined the platinum nanoparticles inside the pore structure on the interior surfaces, rather than allowing them to remain on the surface.

Example 2: Pt nanoparticles were obtained in the same manner as Example 1 was except that Commercial 20% Pt(acac)₂ was dissolved in an ethanol/water (EtOH/H₂O) mixture (15% EtOH/85% H₂O), surface tension=46 mN/m; boiling point=83° C.) to form the metal precursor solution.

### Deposition of Platinum Nanoparticles in Mesopores

Example 3: Pt nanoparticle micropores are filled as described in Example 1 using water as the solvent to dissolve Pt(acac)₂ for the precursor solution to fill a micropore volume of 0.25 cm³/g. The volume of the solvent, i.e., water, for the precursor solution (0.25 cm³/g for 1 g of Vulcan carbon) is equal to or less than the volume of the micropores (0.25 cm³/g). Acetone (C₃H₆O, surface tension=˜25.5 mN/m, boiling point=56° C.) is selected as a second solvent to dissolve Pt(acac)₂ to fill 0.3 cm³/g mesopore volume. The volume of the solvent, i.e., acetone, for the precursor solution (1 g cm³/g for 1 g Vulcan carbon) is added in a volume (0.3 cm³/g)≤V_mesopores (0.3 cm³/g) to selectively fill the mesopores. After the solvent is evaporated, the impregnated carbon support material is annealed to provide uniform Pt nanoparticles within the micropores and the mesopores.

### Deposition of Platinum Nanoparticles in Mesopores

Example 4: Pt nanoparticle micropores are filled as described in Example 3, except that chloroform (CHCl₃, surface tension=˜27.5 mN/m, boiling point=61.2° C.) is selected as a second solvent to dissolve Pt(acac)₂, and mesopores are selectively filled with the solution. After the solvent is evaporated, the impregnated carbon support is annealed to provide uniform Pt nanoparticles within the micropores and the mesopores.

Comparative Example: PT nanoparticles obtained as in Example 1 were compared to commercial 20% Pt/Vulcan carbon nanoparticles using Scanning Electron Microscopy (SEM) in scanning mode (SE) and Scanning Transmission Electron Microscopy (STEM) to analyze the nanoparticle (NP) distribution.

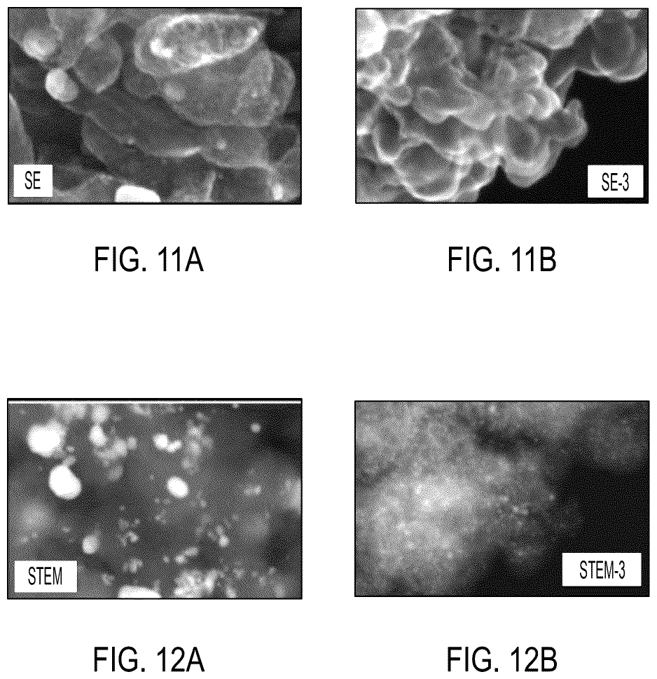

The commercial Pt/Vulcan C in FIG. 11A shows larger, more defined structures on the surface. This suggests a less uniform distribution of nanoparticles, possibly including large clusters of particles. In FIG. 11B, Pt/Vulcan C formed by the methods of the present disclosure shows a smoother surface with fewer large structures on the exterior, implying a more uniform distribution of the nanoparticles that are inside the pores. This is consistent with the capillary-force-assisted impregnation method, which is designed to embed nanoparticles inside the support's pore structure.

FIGS. 12A and 12B are STEM Mode Images of the commercial Pt/Vulcan C and Pt/Vulcan C formed by the methods of the present disclosure, respectively, which provide higher-resolution details of the internal structure and nanoparticle distribution. In FIG. 12A the bright spots which represent Pt nanoparticles are larger, vary in size and are unevenly distributed indicating uneven particle growth and distribution on the surface and inside the porous structure. On the other hand, in FIG. 12B, the bright areas are more diffuse and evenly spread, confirming the presence of smaller Pt nanoparticles more uniformly distributed primarily inside the pores of the carbon support of the Pt/Vulcan C formed by the methods of the present disclosure.

The capillary-force-assisted deposition method of the present disclosure are particularly useful in applications such as proton exchange membrane fuel cells (PEMFCs), water electrolyzers, and CO₂ electrolyzers, where controlling nanoparticle distribution and placement within the pore structure of the carbon support is critical for maximizing catalyst efficiency and durability. The capillary-force-assisted method of the present disclosure ensures that the nanoparticles are selectively deposited inside the micropores or the micropores and mesopores of the carbon support. This reduces the amount of platinum required while enhancing the catalytic surface area, leading to higher catalyst utilization, and making PEMFCs more cost-effective. The method of the present disclosure also reduces platinum agglomeration and leaching, which improves the long-term stability and durability of fuel cells. With better nanoparticle distribution, PEMFCs achieve higher reaction rates at both the anode and cathode, contributing to improved overall efficiency and power output.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A method for selective deposition of metal nanoparticles within into a porous carbon support material, the method comprising:
dissolving one or more first metal precursors MP₁ in a first solvent S₁ having a predetermined surface tension ST₁ and a predetermined boiling point BP₁ to provide a first metal precursor solution MPS₁;
selectively depositing, by capillary impregnation, the one or more first metal precursors MP₁ contained in the first metal precursor solution MPS₁ into selected pores having a first predetermined size P₁ of a porous carbon support material wherein the solvent S₁ is capable of wetting the carbon support, and wherein a volume of the first solvent V_{S1}≤the volume of the selected pores having a first predetermined size V_{P1};
evaporating the first solvent S₁ to deposit the one or more first metal precursors MP selectively into the selected pores having the first predetermined size P₁ of the porous carbon support material; and
annealing the porous carbon support material in a reducing atmosphere to convert the one or more first metal precursors MP₁ into metal nanoparticles confined within the selected pores of the first predetermined size P₁.

2. The method according to claim 1, wherein the predetermined surface tension ST₁ of the first solvent S₁ is in a range of 30-80 mN/m.

3. The method according to claim 1, wherein the predetermined boiling point is in a range of greater than 80-200° C.

4. The method according to claim 1, wherein the pores having a first predetermined size P₁ of a porous carbon support material are micropores wherein the predetermined size P₁ is within a range of less than 2 nm.

5. The method according to claim 1, wherein the first solvent is selected from a mixture of water and ethanol.

6. The method according to claim 1, wherein the one or more metal precursors comprise a metal selected from scandium (Sc), titanium (Ti), vanadium (V), chromium (Cr), manganese (Mn), iron (Fe), cobalt (Co), nickel, (Ni), copper (Cu), zinc (Zn), yttrium (Y), zirconium (Zr), nobium (Nb), molybdenum (Mo), ruthenium (Ru), rhodium (Rh), palladium (Pd), silver (Ag), cadmium (Cd), iridium (Ir), platinum (Pt), and gold (Au).

7. The method according to claim 6, wherein the metal precursor is a platinum (Pt) precursor.

8. The method according to claim 7, wherein the metal precursor is platinum (II) acetylactonate (Pt(acac)₂).

9. The method according to claim 1, wherein the porous carbon support material is selected from ketjen black, Vulcan carbon, mesoporous acetyl black (AB), and a metal and nitrogen-doped carbon.

10. The method according to claim 1, further comprising dissolving one or more second metal precursors MP₂ in a second solvent S₂ having a predetermined surface tension ST₂ and a predetermined boiling point BP₂ to provide a second metal precursor solution MPS₂, wherein the predetermined surface tension of the second solvent ST₂ is 10 to 20 mN/m less than the predetermined surface tension of the first solvent ST₁, and the predetermined boiling point of the second solvent BP₂ is 10 to 20 degrees less than the predetermined boiling point of the first solvent BP₁;
selectively depositing, by capillary impregnation, the one or more second metal precursors MP₂ contained in the second metal precursor solution MPS₂ into selected pores having a second predetermined size P₂ of a porous carbon support material wherein the solvent S₂ is capable of wetting the carbon support, and wherein a volume of the second solvent V_{S2}≤the volume of the pores V_{P2} having a second predetermined size V_{P2};
evaporating the second solvent S₂ to deposit the one or more metal precursors into the pores of having a predetermined size P₂ of the porous carbon support material; and
annealing the porous carbon support material in a reducing atmosphere to convert the one or more metal precursors MP₁ into metal nanoparticles selectively confined within the pores of the first predetermined size P₁, and within the pores of the second predetermined size P₂, respectively.

11. The method according to claim 10, wherein the second solvent S₂ is selected such that the one or more second metal precursors MP₂ is soluble in the second solvent S₂ but insoluble in the first solvent S₁.

12. The method according to claim 10, wherein the pores having a second predetermined size P₂ of a porous carbon support material are mesopores wherein the predetermined size P₂ is within a range of 2 nm to 50 nm.

13. The method according to claim 10, wherein the one or more precursors can be selectively deposited into pores having a third predetermined size P₃ of a porous carbon support material by increasing the volume of the second solvent V_{S2}.

14. The method according to claim 12, wherein the pores having a third predetermined size P₃ of a porous carbon support material are macropores wherein the predetermined size P₃ is within a range of greater than 50 nm.

15. The method according to claim 10, wherein the first solvent S₁ comprises a mixture of water and ethanol in a ratio of 75:25, and the second solvent S₂ is selected from acetone, chloroform or dimethylformamide.

16. The method according to claim 10, wherein the first solvent S₁ has a boiling point higher than 100° C. and the second solvent has a boiling point lower than 100° C.

17. The method according to claim 1, wherein the evaporation of the first solvent S₁ is performed at a temperature of approximately 50° C.

18. A method for increasing a percentage of metal nanoparticles on interior surfaces of pores of a carbon support having a hierarchical pore distribution of micropores, mesopores, and macropores, the method comprising:
dissolving one or more metal precursors MP₁ in a first solvent S₁ having a predetermined surface tension ST₁ and a predetermined boiling point BP₁ to provide a first metal precursor solution MPS₁;
selectively depositing the one or more metal precursors into pores having a first predetermined size P₁ of a porous carbon support material by capillary impregnation wherein the solvent S₁ is capable of wetting the carbon support, and wherein a volume of the first solvent V_{S1}≤the volume of the pores having a first predetermined size V_{P1};
evaporating the first solvent S₁ to deposit the one or more metal precursors MP selectively into the micropores and not into the mesopores and/or macropores of the porous carbon support material; and
annealing the porous carbon support material in a reducing atmosphere to convert the one or more metal precursors into metal nanoparticles electively confined within the micropores of the porous carbon support material.

19. The method according to claim 18, further comprising dissolving one or more second metal precursors MP₂ in a second solvent S₂ having a predetermined surface tension ST₂ and a predetermined boiling point BP₂ to provide a second metal precursor solution MPS₂,
wherein the predetermined surface tension of the second solvent ST₂ is 10 to 20 mN/m less than the predetermined surface tension of the first solvent ST₁, and the predetermined boiling point of the second solvent BP₂ is 10 to 20 degrees less than the predetermined boiling point of the first solvent BP₁;
selectively depositing the one or more metal precursors into mesopores of a porous carbon support by capillary impregnation wherein the solvent S₂ is capable of wetting the carbon support, and wherein a volume of the second solvent V_{S2}≤the volume of the mesopores;
evaporating the second solvent S₂ to deposit the one or more metal precursors into the mesopores of the porous carbon support material; and
annealing the porous carbon support material in a reducing atmosphere to convert the one or more metal precursors into metal nanoparticles selectively confined within the micropores and within the mesopores of the porous carbon support, but not within the macropores of the carbon support.

20. The method according to claim 19, wherein the one or more precursors can be selectively deposited into the macropores of the porous carbon support by increasing the volume of the second solvent V_{S2}.
